(19) United States
(12) Patent Application Publication
(10) Pub. No.: US 2026/0203371 A1
(43) Pub. Date: Jul. 16, 2026

(54) MODULAR MULTIPLICATION USING MATRIX MULTIPLICATION

(71) Applicant: NVIDIA Corporation, Santa Clara, CA (US)

(72) Inventors: Simon Langowski, Cambridge, MA (US); Michael Sullivan, Austin, TX (US); Vinu Joseph, Salt Lake City, UT (US); Gookwon Suh, Lexington, MA (US)

(21) Appl. No.: 19/447,828

(22) Filed: Jan. 13, 2026

Related U.S. Application Data
(60) Provisional application No. 63/745,282, filed on Jan. 14, 2025.

(51) Int. Cl. G06F 17/16; G06F 7/72

(52) U.S. Cl. CPC G06F 17/16; G06F 7/722

(57) ABSTRACT

To enhance the performance of computing arithmetic operations, where the operations can utilize the matrix multiplication process available on processing units. The matrix multiplication process can be implemented as software, a hardware unit that is part of the processing unit, or a combination thereof. Utilizing the matrix multiplication process can utilize available processing bandwidth that would ordinarily not be used for the arithmetic operation. The process can decompose the arithmetic operation to a modular multiplication operation. The modular multiplication operation can be transformed to a redundant representation. The redundant representation can be mapped to the matrix multiplication process. The result can be computed and returned to the calling thread. In some aspects, the result can be a recombination of partial redundant representations that are offset to provide the appropriate place holder values.

### CROSS-REFERENCE

This application claims the benefit of U.S. Provisional Application Ser. No. 63/745,282, filed by Simon Langowski, et al., on Jan. 14, 2025, entitled “MODULAR MULTIPLICATION USING MATRIX MULTIPLICATION,” commonly assigned with this application and incorporated herein by reference in its entirety.

### TECHNICAL FIELD

This application is directed, in general, to directing the operation of a processing unit and, more specifically, to directing the execution of multiplication operations using matrices.

### BACKGROUND

Modular multiplication is used as a main building block in many applications, such as cryptographic algorithms, blockchains, and other privacy-preserving applications. Division operations tend to be slower than multiplication operations and so modular multiplication can be used to leverage high memory bandwidth of a processor. It would be beneficial to further improve the performance of modular multiplication operations on processing units.

### SUMMARY

In one aspect, a method is disclosed. In one embodiment, the method includes (1) decomposing an arithmetic operation being performed on a processing unit into a modular multiplication operation, (2) transforming the modular multiplication operation to a redundant representation consisting of a vector of integers, (3) mapping the redundant representation to inputs of a matrix multiplication process, (4) computing a result from an output of the matrix multiplication process, and (5) returning the result as a response to the arithmetic operation from the matrix multiplication process.

In a second aspect, a system is disclosed. In one embodiment, the system includes (1) a processing unit capable of executing code, and (2) a matrix multiplication unit, capable of receiving an arithmetic operation, decomposing the input numbers into bitwidth blocks aligning to the format used by the processing unit, transforming the decomposed input numbers to a redundant representation consisting of a vector of integers, mapping the redundant representation to inputs of a matrix multiplication process supported by the matrix multiplication unit, computing a result from the output of the matrix multiplication process, and returning the result.

In a third aspect, a non-transitory computer program product having a series of operating instructions stored on a non-transitory computer-readable medium that directs a data processing apparatus, when executed thereby to perform operations is disclosed. The operations include (1) decomposing an arithmetic operation being performed on a processing unit into a modular multiplication operation, (2) transforming the modular multiplication operation to a redundant representation consisting of a vector of integers, (3) mapping the redundant representation to inputs of a matrix multiplication process, (4) computing a result from an output of the matrix multiplication process, and (5) returning the result as a response to the arithmetic operation from the matrix multiplication process.

In a fourth aspect, a processing unit is disclosed. In one embodiment, the processing unit includes (1) a code execution system, capable of analyzing operations and instructions from code and to direct arithmetic operations that satisfy specified conditions to a matrix multiplication process, and (2) a matrix multiplication unit, capable of performing a matrix multiplication process, wherein the process receives an arithmetic operation, decomposes the input numbers into bitwidth blocks aligning to the format used by the processing unit, transforms the decomposed input numbers to a redundant representation consisting of a vector of integers, maps the redundant representation to inputs of a matrix multiplication process supported by the matrix multiplication unit, computes a result from the output of the matrix multiplication process, and returns the result.

In a fifth aspect, a processing unit system is disclosed. In one embodiment, the processing unit system includes (1) a code execution system, capable of analyzing, during a runtime processing of a processing unit of the processing unit system, a code block to determine if the code block is requesting an arithmetic operation that can be performed by a matrix multiplication process, and (2) a matrix multiplication system, capable of executing a matrix multiplication process on the arithmetic operation, wherein the process receives an arithmetic operation, decomposes the input numbers into bitwidth blocks aligning to the format used by the processing unit, transforms the decomposed input numbers to a redundant representation consisting of a vector of integers, maps the redundant representation to inputs of a matrix multiplication process supported by the matrix multiplication unit, computes a result from the output of the matrix multiplication process, and returns the result.

### BRIEF DESCRIPTION

Reference is now made to the following descriptions taken in conjunction with the accompanying drawings, in which:

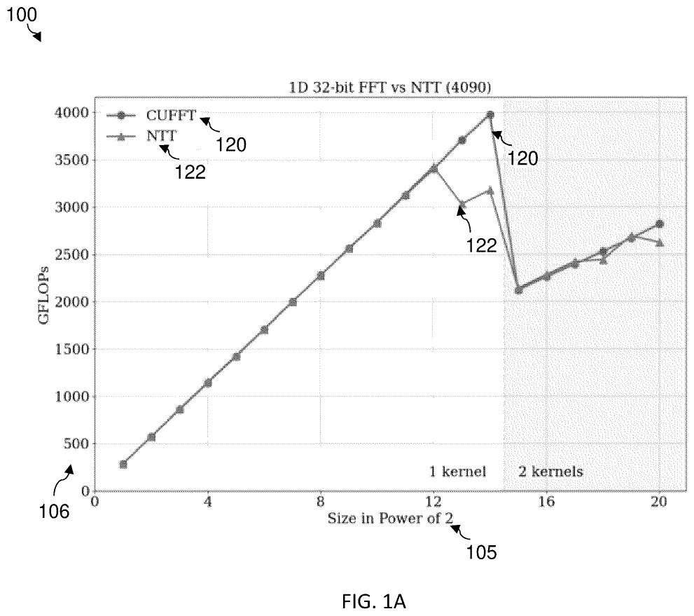

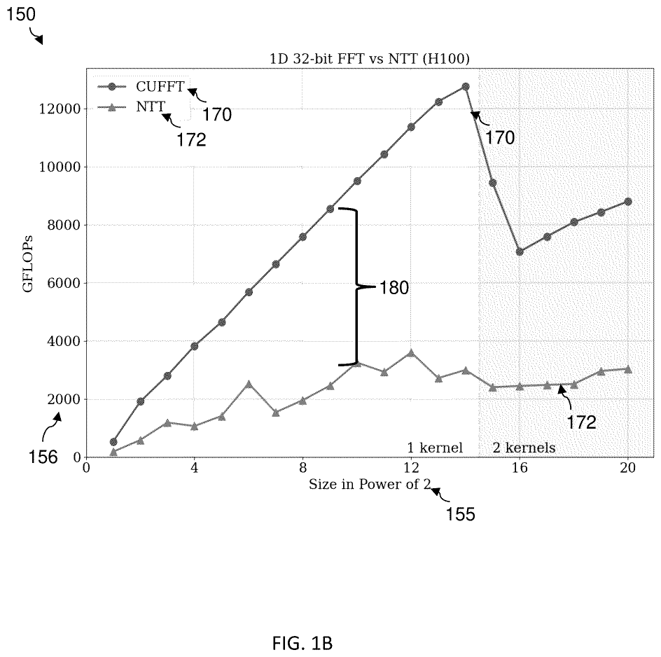

FIG. 1A is an illustration of a diagram of an example chart demonstrating performance gaps executing certain arithmetic operations on a 4090 processing unit;

FIG. 1B is an illustration of a diagram of an example chart demonstrating performance gaps executing certain arithmetic operations on an H100 processing unit;

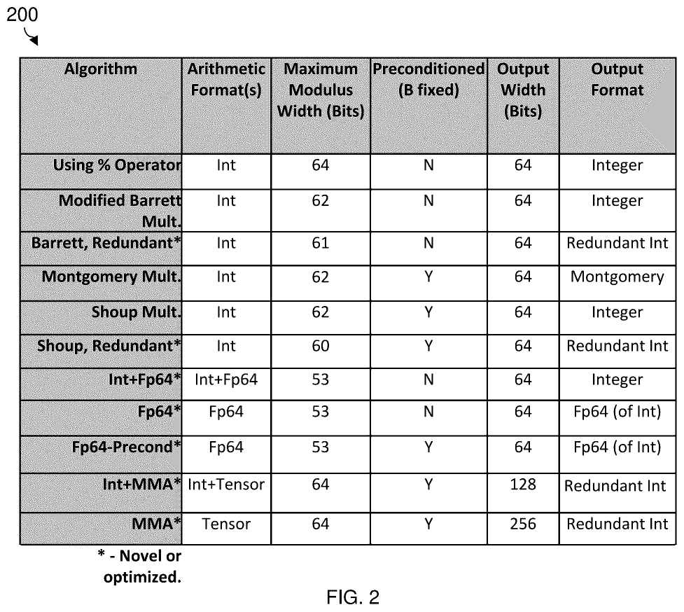

FIG. 2 is an illustration of a diagram of an example table demonstrating the types of algorithms that can be used with this disclosure;

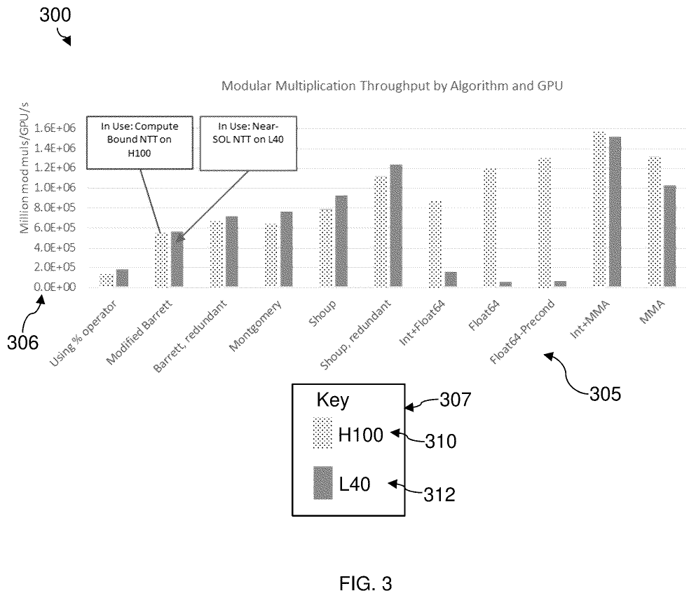

FIG. 3 is an illustration of a diagram of an example graph demonstrating performance gains using modular multiplication to perform the arithmetic operation;

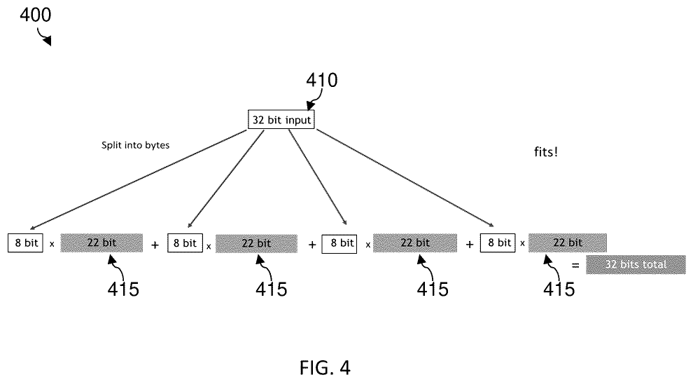

FIG. 4 is an illustration of a block diagram of an example modular multiplication algorithm;

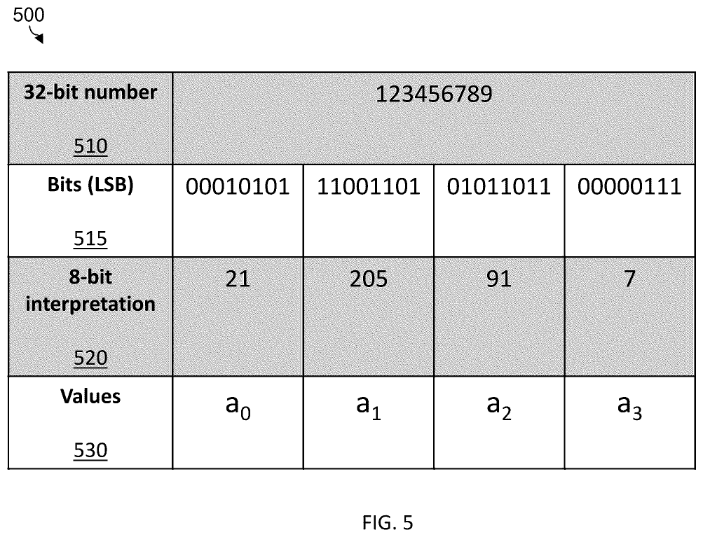

FIG. 5 is an illustration of a diagram of an example table demonstrating the algorithm to decompose a number;

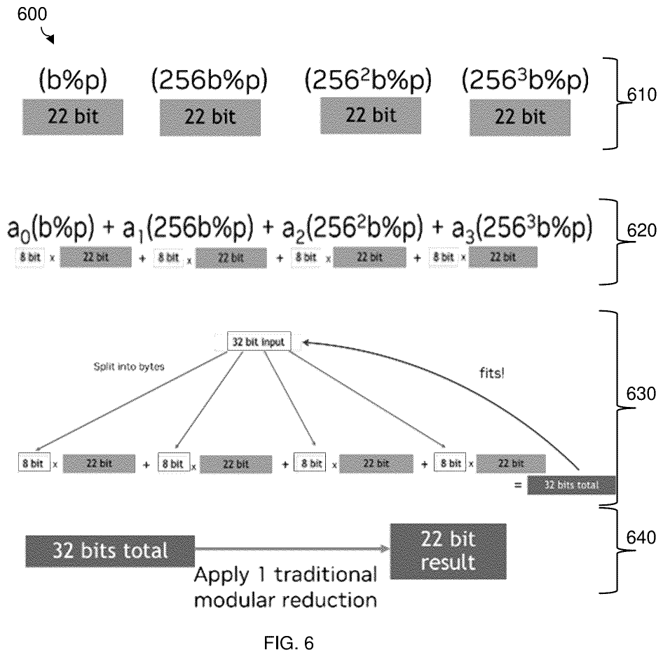

FIG. 6 is an illustration of a diagram of an example flow demonstrating the transformation of a modular multiplication to a redundant representation;

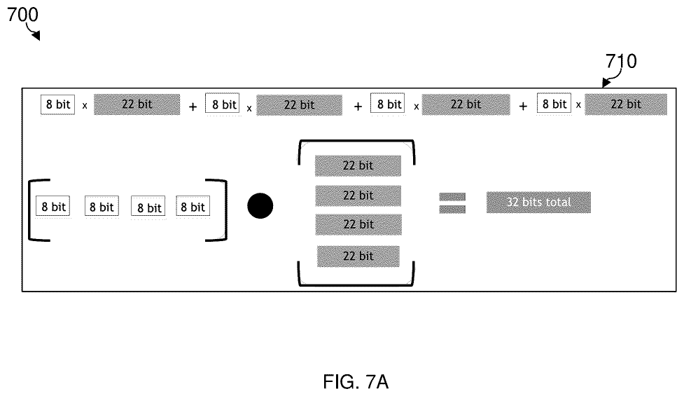

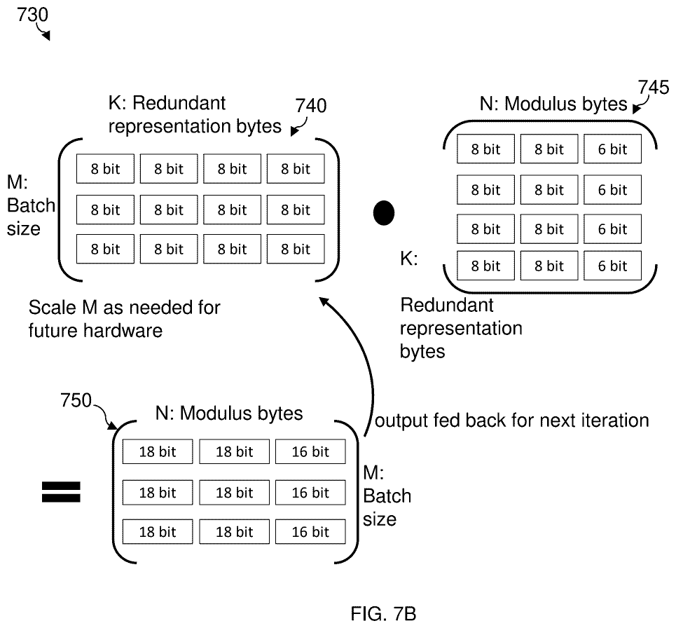

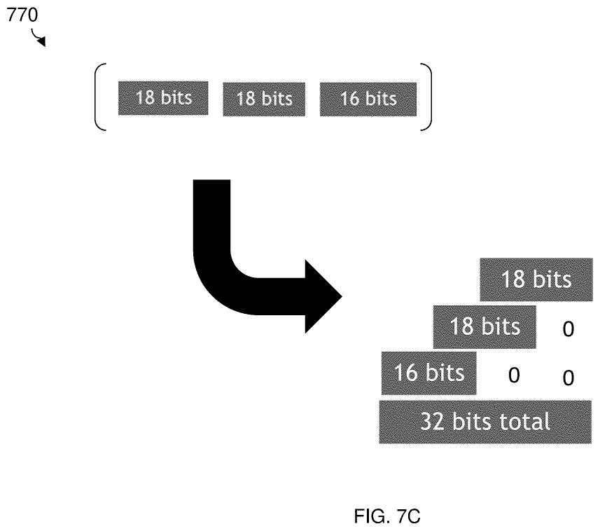

FIG. 7A is an illustration of a diagram of an example flow demonstrating matrix multiplication;

FIG. 7B is an illustration of a diagram of an example flow demonstrating matrix multiplication extending FIG. 7A;

FIG. 7C is an illustration of a diagram of an example place holder offsets;

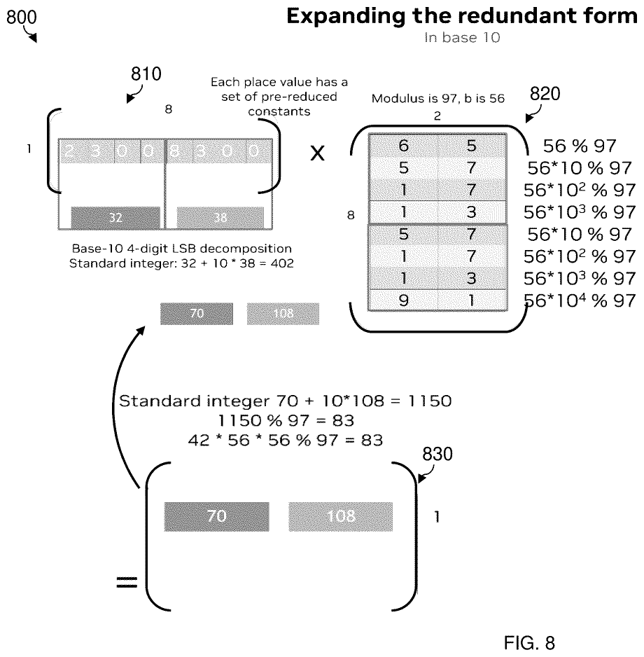

FIG. 8 is an illustration of a diagram of an example redundant form expansion;

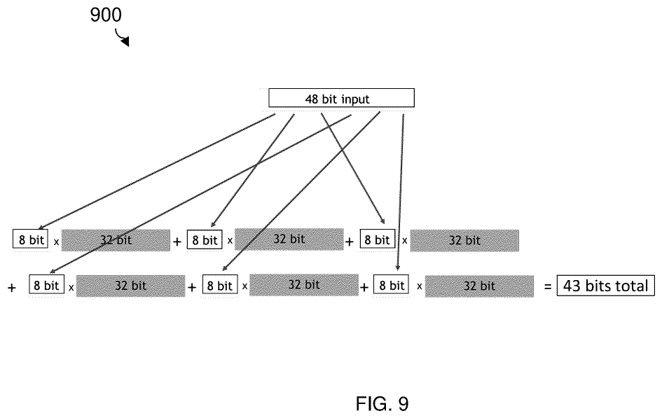

FIG. 9 is an illustration of a diagram of an example decomposition algorithm;

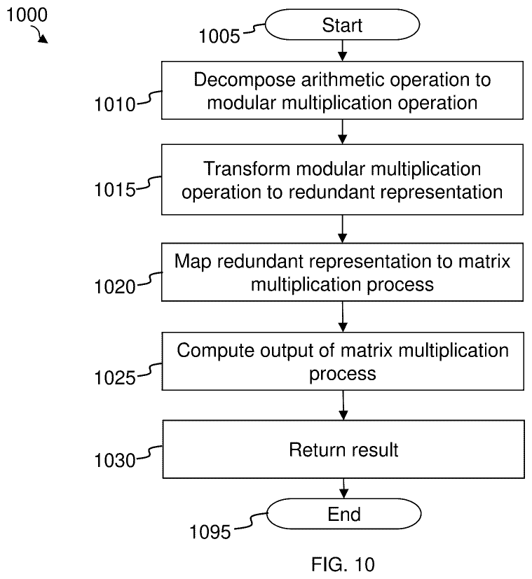

FIG. 10 is an illustration of a flow diagram of an example method to use a matrix multiplication process;

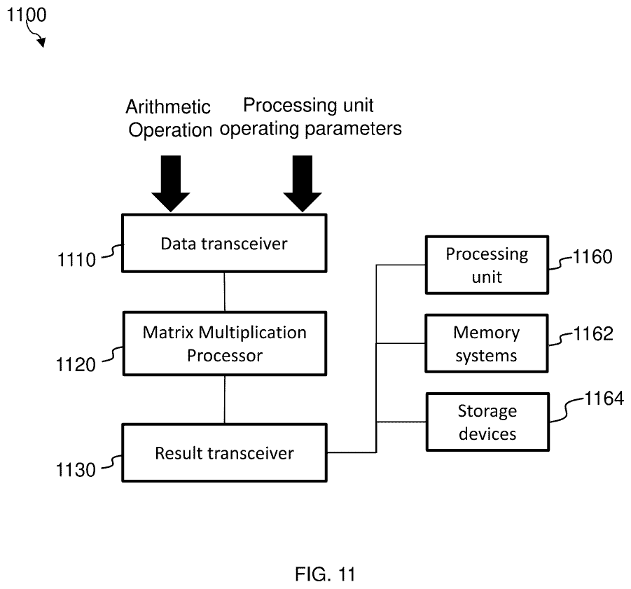

FIG. 11 is an illustration of a block diagram of an example matrix multiplication system; and

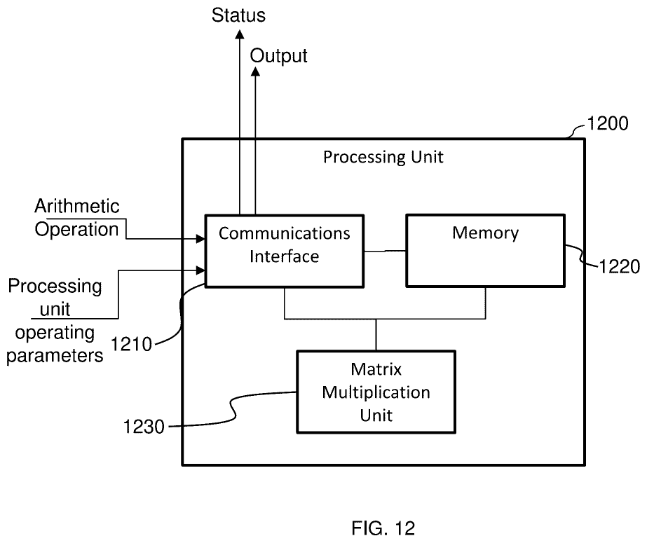

FIG. 12 is an illustration of a block diagram of an example of a matrix multiplication controller according to the principles of the disclosure.

### DETAILED DESCRIPTION

Computing systems can be implemented using one or more processing units that can execute code. A processing unit can be a central processing unit (CPU), a graphics processing unit (GPU), a single instruction multiple data (SIMD) unit, or other types of processing units. The processing unit can perform operations, such as a multiplication or division operation on numbers provided to the processing unit. Some arithmetic operations executing on a processing unit tends to be slower than other operations.

Naïve modular multiplication using the % operator can be slow relative to other operations, making key algorithmic components heavily compute-bound. To leverage the high memory bandwidth of processing units, a faster modular multiplication process can be utilized. Precomputed reduction constants can reduce per-multiply modular reduction cost. Diverse microarchitecture configurations can make developing an efficient implementation across multiple processing unit types challenging.

Modular multiplication can be a main building block that modern post-quantum cryptographic algorithms rely on. For example, modular multiplication can be the core component in the Number Theoretic Transform (NTT) in Fully Homomorphic Encryption (FHE). NTTs are extensively used in CKKS FHE. NTTs can be used in other cryptographic algorithms (e.g., zero knowledge proofs in blockchains or post-quantum cryptography). Relatively straightforward modular multiplication using, for example, a modified Barrett's Reduction algorithm, can achieve sufficient performance on one type of processing unit and fail to have sufficient performance on another processing unit due to low integer bandwidth and high DRAM bandwidth. Prior modular multiplication algorithms exist for integer-only, mixed floating-point, or floating-point only arithmetic.

A modular multiplication operation can be used to improve the performance of these operations. Modular multiplication can be, for example, A*B % M, where A, B, and M are integers. Modular multiplication operations are the main building block for post-quantum algorithms, such as for FHE, zero knowledge proofs (ZKP) (such as for blockchains), and other algorithms like post-quantum cryptography (PQC). Modular multiplication using the ‘%’ operator tends to be slow and a faster solution should be sought to leverage the high memory bandwidth of high-end processing units.

Processing units can devote an area on the chip to specialized low-precision or low dynamic range matrix multiplication units. The matrix multiplication units can be used to improve the performance of modular multiplication operations. Utilizing the matrix capabilities of these accelerators can result in improved performance of modular multiplication with integer or floating-point operations. Additional hardware is not needed.

This disclosure presents ways that matrix multiplication units of processing units can be utilized to improve the performance of modular multiplication. In some aspects, this disclosure can result in three times faster processing of the multiplication operations over traditional cryptographic methods and ten times faster processing over naïve compiler operations. Multiple processing unit optimized modular multiplication routines can be used, depending on the arithmetic capabilities and DRAM bandwidth of each processing unit. The different routines can leverage integer arithmetic, a mixture of integer and double-precision (float64) floating point arithmetic, pure float64 arithmetic, or processing unit specific instructions. The different routines can differ in the precomputed memory traffic and the number representation used.

The process can efficiently use low-precision operations for large numbers by breaking the large numbers into smaller chunks. The processes can reduce the overhead of modular reduction after each multiplication operation, for example, by mapping a one dimensional (1D) array to a two-dimensional (2D) matrix for processing. The processes can map the computation to the matrix multiplication shapes supported by the matrix multiplication units.

The processes can include a vector redundant representation. The concept of a redundant representation (consisting of an integer) can be generalized to a vector of integers. A standard redundant representation for a residue r modulo p can be to use an element of a finite set, such as {r, r+p, r+2*p, . . . , r+k*p}. Each representation can be equivalent to r modulo p and can be used equivalently to reduce computational costs. A full formula for a vector redundant representation for a residue r modulo p can be an element of the set of vectors <x₀, x₁, x₂, . . . > such that there is a k where r+k*p=sum of xᵢ*bᵢ for a fixed set of bᵢ. The bᵢ is an element of the decomposed multiplier, e.g., the second operand to the modular multiplication. The proposed scheme assumes that the multiplier is known a priori so that proper decomposed constants can be calculated. Each bᵢ is the same size as the prime.

The redundant representation can allow for a large modular multiplication to be performed using low-precision operations. The redundant representation can allow multiple multiplications to be performed without explicit modular reduction after each multiplication. In some aspects, this representation can guarantee that there is no overflow when multiplying by implicitly reducing using the natural modulus of the hardware bitwidth, such as 2⁸ bitwidth.

If the modulus is smaller than the processing unit bitwidth, for example, 64 bits, e.g., 56 bits, then fewer bits can be put into each column of the representation, such as 7 bits in 8 columns (for the precomputed matrix), instead of 8 bits of 7 columns (with the last 0), further increasing the number of additions before a correction may be needed. In this example, this means that the algorithm can effectively base 256 and base 128. The second “place value” part of the matrix can be 2^{7b}, 2^{15b}, 2^{23b}, The 2⁷ comes from the base 128 offset, and the increase by 2⁸ from the 256 offset.

The processes can include mapping the redundant representation to inputs of a matrix multiplication process. The matrix multiplication process can be implemented by the processing unit. The matrix multiplication process can be implemented as a dedicated hardware unit of the processing unit. For example, the matrix multiplication of a (M by K)*(K by N)=(M by N) can be mapped as M being the number of elements in a batch, N being the number of bytes in the modulus, and K being the number of bytes in the redundant representation. The improved efficiency can be achieved when K=4N such as when the matrix multiplication process uses an 8-bit input and a 32-bit output. In some aspects, the 8-bit bitwidth size can be preferred over floating point because packing integers into a floating-point block can be space wasteful and floating-point rounding methodology can be undefined for some hardware implementations of the matrix multiplication unit.

The data size and layout of the M by N output matrix can be equal to the M by K input matrix and successive matrix (modular) multiplications can be applied without additional data layout movements. A benefit of this mapping can be that it can enable an output of a modular multiplication to be directly used as an input to the next multiplication without moving data for reshaping. Another benefit of this mapping can be that it can allow the algorithm to scale to larger multiplication engines (processes or units) by increasing the batch size, e.g., the number of independent modular multiplications performed at the same time.

In some aspects, the algorithm can be abstracted. A family of algorithms have been developed, and these various algorithms can be mapped to different matrix multiplication units of different processing units. In some aspects, these algorithms can be used to implement general modular multiplication with more moderate efficiency results versus traditional methods under specific sets of circumstances. Efficiency can depend on the dedicated hardware support for matrix multiplication on the processing unit.

The algorithm can support a non-linear operation. The composition of matrix multiplication implements a product of linear operators. Since modular multiplication can be non-linear, the non-linear components need to be transformed into linear operations. The disclosed processes can represent two types of data (1) floating point operations (which are non-linear) and (2) type-reinterpretation (where data, stored in a register or memory, can be viewed as a different data type than as it was originally created).

The algorithm uses a vector redundant representation. The concept of a redundant representation (consisting of an integer) can be generalized to a vector of integers. A standard redundant representation for a residue r modulo p can be to use an element of a finite set {r, r+p, r+2*p . . . r+k*p}. Each representation can be equivalent to r modulo p and can be used equivalently to reduce computational costs. Let an integer x be a standard redundant representation for a number r. In a traditional base system, a number x can be represented by a series of digits. For example, if x=1234, this means x=1*10³+2*10²+3*10¹+4*10⁰. In the computer, this base will be a power-of-two for efficiency. This expression can be written as a dot product between a vector of coefficients <1,2,3,4> and a vector of bases <10³, 10², 10¹, 10⁰>. This form can be generalized to allow other sequences, for example, <1, 256, 256, 256²>. In contrast to a traditional system, this form can be indeterminate, meaning that there are multiple possible ways to express x=1234:<210,4,0,0> or <210,0,4,0> or <210,2,2,0>.

In some aspects, another generalization that can be used is the sequence <1, 256, 256², 256³, 128, 128*256, 128*256², 128*256³>. In a traditional base system, 1) powers of the base should be used, and 2) a digit can have a value as large as the base. These restrictions can create further indeterminacy. In general, a vector representation of x can be the dot product between a vector of “digits”<x₀, x₁, x₂, . . . > and a vector of “bases”<b₀, b₁, . . . >. This can be useful because matrix multiplication essentially performs many dot products. A full formula for a vector redundant representation for a residue r modulo p can be an element of the set of vectors <x₀, x₁, x₂, . . . > such that there is a k where

$$r + k * p = {\sum }_{i = 0}^{n} {x}_{i} * {b}_{i}$$

for some set of (predefined)<b₀, b₁, . . . >. The allowed values for xᵢ and bᵢ are determined by the data types they are contained in. Therefore, they can be non-integers or negative numbers such as when using floating point.

With the above algorithms, a matrix-multiplication algorithm can be constructed for modular-multiplication. Given that the dot product of <x₀, x₁, x₂, . . . > and <b₀, b₁, . . . > is x, then the dot product of <x₀, x₁, x₂, . . . > and <tb₀% p, tb₁% p . . . > is a redundant form for tₓ% p. The exact choice of <b₀, b₁, . . . > depends on the non-linear operator involved, the dimensions for matrix-multiplication available on the hardware, and the arrangement of columns and rows in the matrix. The rows and columns can be permuted while maintaining correctness.

The next step can be to map the vector <tb₀% p, tb₁% p . . . > into a matrix. The values of xᵢ can be determined by the data type, where each of these values in this vector can be an integer less than p, which might not fit in the underlying data type. Each element tbᵢ% p can be mapped into a vector (using another vector redundant decomposition) and then interpret this “vector of vectors” as a matrix. This decomposition will be redundant and have digits in the underlying data type. For example, if there are 8 columns in the matrix with an 8-bit data type, then there can be up to a 64-bit modulus, using a standard base-256 decomposition. Since the moduli length in applications often varies, other decompositions can be used when they are advantageous. If there are 8 columns and a 56-bit modulus, then a base-128 decomposition will result in better efficiency in downstream tasks.

The processes create a precomputed matrix of values. To use a matrix-matrix product, the multiple input vectors <x₀, x₁, x₂, . . . > can be stacked into a matrix. This matrix can be multiplied by the precomputed matrix, which performs a batch of simultaneous modular multiplications (one for each vector) with the same number and modulus. The matrix multiplication step can be repeated for some amount of modular arithmetic (using multiple precomputed matrices). To get the final result, the output can be multiplied with the vector of bases to get a standard integer redundant representation and reduced with traditional methods. This computational cost can be amortized by the repetition of the matrix multiplication step. In the example shown in FIG. 8, the vector of bases is <1,10,100,1000,10,100,1000,10000> and the vector of digits is <2,3,0,0,8,3,0,0>. The precomputed numbers are decomposed with respect to <1, 10>. The nonlinear operator can be the digit decomposition of a 4-digit number into digits.

Turning now to the figures, FIG. 1A is an illustration of a diagram of an example chart 100 demonstrating performance gaps executing certain arithmetic operations on a 4090 processing unit. Chart 100 compares the performance of an NTT algorithm using Barrett's reduction when running on a NVIDIA 4090 GPU (AD102). Chart 100 has an x-axis 105 showing the batch size in powers of 2, and a y-axis 106 showing the number of gigaflops (floating operations per second). A cuFFT (e.g., cuFFT is a CUDA library that provides GPU-accelerated Fast Fourier Transform (FFT) implementations) performance line 120 is shown compared against an NTT performance line 122.

FIG. 1B is an illustration of a diagram of an example chart 150 demonstrating performance gaps executing certain arithmetic operations on a H100 processing unit. Chart 150 compares the performance of an NTT algorithm using Barrett's reduction when running on a NVIDIA H100 GPU (GH100). Chart 150 has an x-axis 155 showing the batch size in powers of 2, and a y-axis 156 showing the number of gigaflops. A cuFFT performance line 170 is shown compared against an NTT performance line 172.

Comparing chart 100 and chart 150, it can be seen that the 4090 GPU nears SOL performance, due to its fast integer arithmetic and relatively low DRAM bandwidth. SOL performance is a performance measure against the theoretical speed of light (SOL) limit of the hardware design. An increase in an algorithm's efficiency can lead to the algorithm approaching the SOL performance benchmark. While the H100's absolute performance can be slightly better, it lags far behind SOL, and it can be heavily compute-bound due to the GPU's relatively low integer arithmetic throughput considering its high DRAM bandwidth. Bracket 180 shows the potential performance gain available when the disclosed processes are implemented.

FIG. 2 is an illustration of a diagram of an example table 200 demonstrating the types of algorithms that can be used with this disclosure. Table 200 summarizes the features of the different modular multiplication routines considered for this disclosure. The disclosure presents a suite of modular multiplication routines with different operation mixes, memory traffic requirements, and number representations.

Four specific differences between the algorithms make them suitable for different processing units. (1) In some aspects, different arithmetic formats can be used: Modular multiplication is over integers, while using double-precision floating point arithmetic and processing unit instructions can produce the correct integer output.

(2) In some aspects, different maximum modulus bitwidths can be used: While the moduli are baked into the application algorithms at design time, there can be some flexibility in the numbers chosen. In some aspects, it can be possible to support a smaller modulus bitwidth in order to use a faster performing algorithm, (e.g., the transforming can select a smaller modulus than specified by an application algorithm, such as to improve performance on the processing unit).

(3) In some aspects, preconditioning (fixing the multiplier) can be used: One operand of each modular multiplication can be known a priori, e.g., at compile time. Thus, some calculations can be replaced with pre-computed values. This can expose a computation vs. memory traffic tradeoff which can be taken advantage of by certain processing units.

(4) In some aspects, redundant or different output formats can be used: In some aspects, it can be faster to produce a value that is related to the modular multiplication result instead of computing each module separately. Chains of instructions can be performed in this alternate representation, with periodic conversion back to a least residue form.

FIG. 3 is an illustration of a diagram of an example graph 300 demonstrating performance gains using modular multiplication to perform the arithmetic operation. Graph 300 shows the performance of the different routines running on demonstration systems, specifically a NVIDIA H100 and a NVIDIA L40. Graph 300 has an x-axis 305 showing the different modular multiplication algorithms, a y-axis 306 showing the millions of modular multiplications per GPU per second, and a key 307 indicating an H100 GPU 310 and a L40 312.

Barrett's reduction achieves a 3.82× speedup over naïve modular multiplication, while its H100 speed can be limited by the integer arithmetic throughput. Preconditioning and redundant forms reduce some computation, increasing the total speedup to 5.52× and 7.85×, respectively. A pure float64 routine eliminates integer operations, increasing this speedup to 8.43× (or 9.12× when pre-conditioned). The novel MMA-based routine leverages the matrix multiplication unit (in case of these NVIDIA chips, the Tensor core) instructions to net a 10.97× speedup. The disclosed processes, utilizing the matrix multiplication process, can further alleviate the compute bottleneck, for example, potentially leading to ~3× speedups or more.

FIG. 4 is an illustration of a block diagram of an example modular multiplication algorithm 400. Modular multiplication algorithm 400 demonstrates how a 32-bit number 410 can be split into 8-bit bitwidths with a 22-bit number 415. In some aspects, 22-bit number 415 can be precomputed saving compute cycles at run time on the processing unit. In aspects where the modulus is 22-bits or less, then the redundant form can fit into a 32-bit bitwidth. In some aspects, the processing unit utilizes 32-bit bitwidth and the largest modulus used in the transforming is 22-bits.

FIG. 5 is an illustration of a diagram of an example table 500 demonstrating the algorithm to decompose a number. Table 500 demonstrates decomposing a number into a modular format suitable for a modular multiplication operation, such as reinterpreting a 32-bit number as four 8-bit numbers. A 32-bit number 510 can be represented by a bit representation 515. Bit representation 515 can be represented by a base 10 number 520. Base 10 number 520 can then be abstracted to the values 530. Mathematically, the equation is a=a₀+256a₁+2562a₂+2563a₃. Rearranging the equation results in redundant representation of ab % p=[a0 (b % p)+a1(256b % p)+a2(2562b % p)+a3(2563b % p)] % p. Each term can be represented by an 8-bit number multiplied by a 22-bit number with a modulus applied.

FIG. 6 is an illustration of a diagram of an example flow 600 demonstrating the transformation of a modular multiplication to a redundant representation. In some aspects, the redundant representation can have more than one row in the input matrix, and the computing recomposes the result of each row prior to computing a subsequent row. Flow 600 shows decomposition and transformation steps. The goal of modular multiplication can be to compute: a*b mod p. a and b represent the two inputs and p is a modulus. The size of these values can be determined by a target algorithm. The core of the algorithm can be applied to integer arithmetic. The algorithm can be designed so that it can be formatted into a matrix shape (with low precision arithmetic) later.

In some aspects, the algorithm can start with a mathematical identity. Let a be a 32-bit number and aᵢ be the i-th byte of a (such that a=a₀+256 a₁+2562 a₂+2563 a₃), then for any number b and modulus p, ab % p=[a₀(b % p)+a₁(256b % p)+a₂(256²b % p)+a₃(256³b % p)] % p. The square bracket expression (inside [ ]) requires a bounded number of bits to express. In this example, each aᵢ is 8-bits, and each parenthesis expression (inside ( ) is at most log p bits. In ordinary multiplication, the product grows after each operation, while this square bracket expression remains bounded. In this example, for a 22-bit modulus p, it will be bounded by 32-bits. This intermediate 32-bit form can be called a redundant representation. The redundant representation can be used directly as the input a without requiring the computation of the final % p. The modular multiplication can be computed without using a modular reduction operator, which can be costly in terms of compute cycles. If the expressions in parentheses are computed ahead of time, then for a fixed b and p the compute multiplies and additions for the square bracket expressions can be simplified.

The steps of the algorithm can be summarized. First, some numbers are precomputed based on the value to multiply by b and the modulus p (shown by a bracket 610 to precompute reduced factors). An input can be decomposed into bytes, and dot-producted with the precomputed values (shown by a bracket 620 to dot product byte-decomposition with precomputed reduced factors, creating redundant representation outputs). This process can be repeated for some number of modular multiplications (shown by a bracket 630 to repeat for some number of modular multiplications). Then a final modular reduction can be applied (shown by a bracket 640 to perform a final modular reduction). Using this method will require less computation than applying a traditional modular reduction after each multiplication. The above algorithm performs a dot product. Matrix multiplication performs dot products between row vectors and column vectors.

FIG. 7A is an illustration of a diagram of an example flow 700 demonstrating matrix multiplication. The dot products can be packed into matrix-multiplication, as shown in dot product 710. The four 8-bit decomposed blocks representing the input number can be multiplied by a pre-computed 22-bit number to achieve a result of a 32-bit number.

FIG. 7B is an illustration of a diagram of an example flow 730, extending flow 700. Flow 730 illustrates multiplication for multiple rows and can be extended to as many rows as needed. A redundant representation can be byte-decomposed, as shown in a matrix A 740. This can then be matrix-multiplied with some precomputed constants, as shown in a matrix B 745. The output of the matrix multiplication, as shown in a matrix C 750, can be fed directly back as the input to the next matrix multiplication, repeating the same pattern as in an integer version.

When arranging the algorithm into matrix form, the batch size becomes the M dimension, the K dimension can be the bytes in the redundant representation, and the N dimension can be the bytes in the modulus. In some aspects, K=4N is used to use implicit conversion without data movement so that an M by N matrix can be the same data size as an M by K matrix. The M dimension can be scaled without restriction as needed for the hardware.

This algorithm can be represented by a generic pseudocode instruction for a processing unit, for example, the pseudocode shown in Code Listing 1. In some aspects, the instruction format can vary to match the instruction formatting for a specific processing unit. In some aspects, the matrix numbers can vary to match the bitwidth size of the processing unit being targeted. For example, some processing units use 8-bit bitwidth, some use 16-bit bitwidth, and others use 256-bit bitwidth.

Code Listing 1: Example pseudocode for a
matrix multiplication process instruction

```
    x IMMA.m16n8k32
where, x is an 8-bit integer type,
  IMMA specifies the matrix multiplication accumulator, i.e., perform
  A*B+C,
  A represents a 16 by 32 matrix,
  B represents a 32 by 8 matrix, and
  C represents a 16 by 8 matrix.
```

Code Listing 2 demonstrates example pseudocode instructions for a processing unit that has a hardware matrix multiplication unit. Code Listing 3 demonstrates example pseudocode instructions when the processing unit supports integer operations. Code Listing 2 and Code Listing 3 utilize the NVIDIA H100 GPU as the example processing unit. Using the matrix multiplication unit with integer operations can utilize a partial recombination method. Two or more accumulators, where each one can be offset from the other can be combined to form a larger integer. For example, two 21-bit accumulators, where one can be offset by 8-bits, can be combined to form a 29-bit accumulator. This method can allow each computation to proceed in parallel, thereby improving the time to complete the overall operation.

Code Listing 2: Example pseudocode for
using a matrix multiplication unit

```
_{——}device_{——}uint4 mma (uint4 a, uint b, uint4 c) {
  // Processing unit requires a mov instruction because it is not quite
  row-ordered
  swap (a [1], a [2])
  return IMMA.m16n8k32 (a, b, c);
```

Code Listing 3: Example pseudocode for using a matrix
multiplication unit and integer operations

```
_{——}device_{——}uint2 mma (uint2 a, uint b, uint2 c){
  uint4 ct {c [0],0,c [1],0};
  ct = IMMA.m16n8k16 (a, b, ct);
  uint2 r {ct [0] + 256*ct [1], ct [2] + 256*ct [3]};
  return r; // becomes a
```

FIG. 7C is an illustration of a diagram of an example place holder offsets 770. Place holder offsets 770 demonstrates how the result matrix can be recombined to form a proper result for the arithmetic operation. Each result in the output matrix, for example one row from matrix C 750, can be combined using a place holder offset to compute the final 32-bit number as the result of the operation. Each output of matrix C 750 can be a multiplication row using conventional multiplication techniques.

FIG. 8 is an illustration of a diagram of an example redundant form expansion 800. Redundant form expansion 800 demonstrates an example modular multiplication using example numbers. In this example, base 10 arithmetic can be being used. Let an input matrix A 810 take the digit decomposition of the value a. A matrix B 820 contains the precomputed values, also expressed with low-precision arithmetic. Decomposing these values for the integer algorithm was not needed in this example. In order to get the corresponding integer value, the algorithm needs to recompose the outputs in a matrix C 830. Specifically, computing 70+10*108 is used to get the integer redundant representation, and then perform the final modular reduction.

In some aspects, the algorithm can recompose to an integer after each matrix operation. In some aspects, the algorithm can add additional rows to matrix B 820 to account for the new place values. This allows <70, 108> to become the new input to be digit (byte)-decomposed (replacing <32, 38>) without additional operations. Therefore, modular multiplication can be implemented with the operation of matrix multiplication while not using other operations.

FIG. 9 is an illustration of a diagram of an example decomposition algorithm 900. Decomposition algorithm 900 demonstrates that the algorithm can be used with different bitwidth numbers. In this scenario, a 48-bit input number can be decomposed to 6 8-bit blocks, each with a pre-computed 32-bit number and modulus. This can result in having 43-bits store the 32-bit residues.

FIG. 10 is an illustration of a flow diagram of an example method 1000 to use a matrix multiplication process. Method 1000 can be performed on a computing system, for example, matrix multiplication system 1100 of FIG. 11 or matrix multiplication controller 1200 of FIG. 12. The computing system can be one or more processors in various combinations (e.g., CPUs, GPUs, SIMDs, or other types of processors), a data center, a cloud environment, a server, a laptop, a mobile device, a smartphone, a PDA, or other computing system capable of compiling code for a targeted processing unit. Method 1000 can be encapsulated in software code or in hardware, for example, an application, code library, code module, dynamic link library, module, function, RAM, ROM module, and other software and hardware implementations. The software can be stored in a file, database, or other computing system storage mechanism. Method 1000 can be partially implemented in software and partially in hardware. Method 1000 can perform the steps for the described processes, for example, transforming an input into a format suitable for use with a matrix multiplication process and recompose the output to compute a final result.

Method 1000 starts at a step 1005 and proceeds to a step 1010. In step 1010, an arithmetic operation can be received. The operation can be generated by a processing unit or received as an instruction from an application or memory location. The input number can be decomposed into a bitwidth value that can be appropriate for the processing unit. For example, the bitwidth can be 8-bits, 64-bits, 256-bits, or other bitwidths. A second value with a modulus, to be multiplied by the input number, can be pre-computed or computed at the time the arithmetic operation is executed.

In a step 1015, the decomposed numbers can be arranged into a redundant representation format. In some aspects, this can be represented by each decomposed value being multiplied by a second number. In some aspects, the redundant representation can have more than one row in the input matrix, and the computing recomposes the result of each row prior to computing a subsequent row. In some aspects, the input numbers can be decomposed into bitwidth blocks aligning to the format used by the processing unit.

In a step 1020, the redundant representation can be arranged into a matrix format, such that a vector dot product operation can be performed between the decomposed values and the secondary number with a modulus. The first matrix can include the decomposed values. The second matrix can include the secondary number with the modulus. The matrix format can be a format that is compatible with the matrix multiplication process being used by the processing unit. In some aspects, the matrix multiplication process can be software based, for example, implemented virtually by the processing unit. In some aspects, the matrix multiplication process can be implemented by a hardware unit, for example a matrix multiplication unit. In some aspects, the matrix multiplication unit can be called a tensor unit. In some aspects, the data format used can be aligned to the matrix multiplication process thereby reducing processing time of the matrix multiplication process.

In a step 1025, the output of the matrix multiplication process can be computed. The output can be stored in a third matrix. In some aspects, the output can be recomposed into the base of the input number. In some aspects, the recomposition can use placeholder values, where each element of the matrix can be offset by the appropriate placeholder value for the base value (e.g., the matrix multiplication process adds a row to a second matrix, where each row represents a different placeholder value). The output, once recomposed or combined, can be the result of the arithmetic operation.

In a step 1030, the result can be returned for further processing. In some aspects, the result can be returned as a response to the arithmetic operation from the matrix multiplication process. The result can be used as an input into another operation, stored at a memory location, or returned to a calling application. Method 1000 ends at a step 1095.

FIG. 11 is an illustration of a block diagram of an example matrix multiplication system 1100. Matrix multiplication system 1100 can be implemented in one or more computing systems or one or more processors. In some aspects, matrix multiplication system 1100 can be implemented using a matrix multiplication controller such as matrix multiplication controller 1200 of FIG. 12. Matrix multiplication system 1100 can implement one or more aspects of this disclosure, such as method 1000 of FIG. 10.

Matrix multiplication system 1100, or a portion thereof, can be implemented as an application, a code library, a dynamic link library, a function, a module, a header file, other software implementation, or combinations thereof. In some aspects, matrix multiplication system 1100 can be implemented in hardware, such as a ROM, a graphics processing unit, or other hardware implementation. In some aspects, matrix multiplication system 1100 can be implemented partially as a software application and partially as a hardware implementation. Matrix multiplication system 1100 can be a functional view of the disclosed processes and an implementation can combine or separate the described functions in one or more software or hardware systems.

Matrix multiplication system 1100 includes a data transceiver 1110, a matrix multiplication processor 1120, and a result transceiver 1130. The output, e.g., the result, can be communicated to a data receiver, such as one or more of a processing system 1160 (one or more combinations of processor units or processing cores), one or more memory systems 1162, or one or more storage devices 1164.

In some aspects, the results of the matrix multiplication system 1100, such as those communicated to the one or more processing systems 1160, one or more storage devices 1164, or one or more memory systems 1162, can be used as an input into another process or system, for example, being used as an input to other arithmetic operations.

Data transceiver 1110 can receive the input parameters, including the numbers for the arithmetic operation, and one or more matrix multiplication parameters. In some aspects, data transceiver 1110 can be part of matrix multiplication processor 1120.

Result transceiver 1130 can communicate one or more outputs, to one or more data receivers, such as processing systems 1160, one or more memory systems 1162, one or more storage devices 1164, or other related systems, whether located proximate result transceiver 1130 or distant from result transceiver 1130. Data transceiver 1110, matrix multiplication processor 1120, and result transceiver 1130 can be, or can include, conventional interfaces configured for transmitting and receiving data. Data transceiver 1110, matrix multiplication processor 1120, or result transceiver 1130 can be implemented as software components, for example, a virtual processor environment, as hardware, for example, circuits of an integrated circuit, or combinations of software and hardware components and functionality. The functionality described for these components remains intact regardless of how the functionality is implemented.

Matrix multiplication processor 1120 (e.g., one or more processing units such as processor 1230 of FIG. 12) can implement the analysis and algorithms as described herein utilizing the input parameters. Matrix multiplication processor 1120 can be one or more of a tensor, dedicated hardware component (e.g., a dedicated matrix multiplication unit), a matrix multiplication unit, a multicore processor, a multiprocessor system, or a streaming multiprocessor. Matrix multiplication processor 1120 can be implemented by a central processing unit (CPU), a graphics processing unit (GPU), or other types of processors. In some aspects, matrix multiplication processor 1120 utilizes a 32-bit bitwidth and the largest modulus used in the transforming is 22-bits. In some aspects, the input numbers can be decomposed into bitwidth blocks aligning to the format used by matrix multiplication processor 1120.

In some aspects, matrix multiplication processor 1120 can be a code execution system, capable of analyzing operations and instructions from code and direct arithmetic operations that satisfy specified conditions to a matrix multiplication process. In some aspects, matrix multiplication processor 1120 can be a code execution system, capable of analyzing, during a runtime processing of a processing unit of the processing unit system, a code block to determine if the code block is requesting an arithmetic operation that can be performed by a matrix multiplication process. In some aspects, matrix multiplication processor 1120 can be a matrix multiplication unit, capable of performing a matrix multiplication process, wherein the process receives an arithmetic operation, decomposes the input numbers into bitwidth blocks aligning to the format used by the processing unit, transforms the decomposed input numbers to a redundant representation consisting of a vector of integers, maps the redundant representation to inputs of a matrix multiplication process supported by the matrix multiplication unit, computes a result from the output of the matrix multiplication process, and returns the result. In some aspects, matrix multiplication processor 1120 can be configured to perform the functions of a code execution system and the matrix multiplication unit.

A memory or data storage system of matrix multiplication processor 1120 (such as a core cache, L1 cache, L2 cache, or other memory systems) can be configured to store the processes and algorithms for directing the operation of matrix multiplication processor 1120. Matrix multiplication processor 1120 can include a processor that is configured to operate according to the analysis operations and algorithms disclosed herein, and an interface to communicate (transmit and receive) data.

FIG. 12 is an illustration of a block diagram of an example of a matrix multiplication controller 1200 according to the principles of the disclosure. Matrix multiplication controller 1200 can be stored on one computer or multiple computers. The various components of matrix multiplication controller 1200 can communicate via wireless or wired conventional connections. A portion or a whole of matrix multiplication controller 1200 can be located at one or more locations. In some aspects, matrix multiplication controller 1200 can be part of another system (e.g., processor, core, server, or other systems), and can be integrated with one device, such as a part of a processing system. Matrix multiplication controller 1200 represents a demonstration of the functionality employed for the disclosure, and implementations can use a variety of devices, for example, circuits of a processor, dedicated processors, virtual systems, servers, other computing or processing systems, be in software or hardware, or various combinations thereof.

Matrix multiplication controller 1200 can be configured to perform the various functions disclosed herein including receiving input parameters and generating results from execution of the methods and processes described herein, such generating a final result representing the output from the arithmetic operation. Matrix multiplication controller 1200 includes a communications interface 1210, a memory 1220, and a processor 1230.

Communications interface 1210 is configured to transmit and receive data. For example, communications interface 1210 can receive the input parameters. Communications interface 1210 can transmit the output or interim outputs. In some aspects, communications interface 1210 can transmit a status, such as a success or failure indicator of matrix multiplication controller 1200 regarding receiving the various inputs, transmitting the generated outputs, or producing the results.

In some aspects, processor 1230 can perform the operations as described by matrix multiplication processor 1120. Communications interface 1210 can communicate via communication systems used in the industry. For example, wireless or wired protocols can be used. Communications interface 1210 is capable of performing the operations as described for data transceiver 1110 and result transceiver 1130 of FIG. 11.

Memory 1220 can be configured to store a series of operating instructions that direct the operation of processor 1230 when initiated, including supporting code representing the algorithm for implementing the matrix multiplication process instruction. Memory 1220 is a non-transitory computer-readable medium. Multiple types of memory can be used for the data storage systems and memory 1220 can be distributed.

Processor 1230 can be one or more processors. Processor 1230 can be a combination of processor types, such as a CPU, a GPU, a single instruction multiple data (SIMD) processor, or other processor types. Processor 1230 can be a code execution system. Processor 1230 can be a matrix multiplication unit.

Processor 1230 can be a virtual process supported by a processing unit. Processor 1230 can be configured to produce the output, one or more interim outputs, and statuses utilizing the received inputs. Processor 1230 can determine the output using parallel processing. Processor 1230 can be an integrated circuit. In some aspects, processor 1230, communications interface 1210, memory 1220, or various combinations thereof, can be an integrated circuit. Processor 1230 can be configured to direct the operation of matrix multiplication controller 1200. Processor 1230 includes the logic to communicate with communications interface 1210 and memory 1220, and performs the functions described herein. Processor 1230 is capable of performing or directing the operations as described by matrix multiplication processor 1120 of FIG. 11.

In some aspects, matrix multiplication system 1100 or matrix multiplication controller 1200 can be part of a machine learning system. In some aspects, matrix multiplication system 1100 or matrix multiplication controller 1200 can perform the operations as described for the matrix multiplication processes. In some aspects, matrix multiplication system 1100 or matrix multiplication controller 1200 can be part of another system that receives the input parameters, input text, and visuals. In some aspects, matrix multiplication system 1100 or matrix multiplication controller 1200 can be part of a machine learning system, an AI generative tool, or can be in a data center, a cloud system, an edge system, a corporate system, or other types of systems or locations. In some aspects, matrix multiplication system 1100 or matrix multiplication controller 1200 can be part of a machine learning system, where matrix multiplication processor 1120 can be part of the machine learning processes. In some aspects, matrix multiplication system 1100 or matrix multiplication controller 1200 can implement a non-transitory computer program product having a series of operating instructions stored on a non-transitory computer-readable medium that directs a data processing apparatus when executed thereby to perform operations, the operations comprising the steps described herein for this disclosure, such as method 1000 of FIG. 10. In some aspects, matrix multiplication system 1100 or matrix multiplication controller 1200 can implement a non-transitory computer-readable medium having a series of operating instructions that direct a data processing apparatus when executed thereby to perform the operations.

A portion of the above-described apparatus, systems or methods may be embodied in or performed by various digital data processors or computers, wherein the computers are programmed or store executable programs of sequences of software instructions to perform one or more of the steps of the methods. The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein. The data storage media can be part of or associated with digital data processors or computers.

The digital data processors or computers can be comprised of one or more GPUs, one or more CPUs, one or more of other processor types, or a combination thereof. The digital data processors and computers can be located proximate to each other, proximate to a user, in a cloud environment, a data center, or located in a combination thereof. For example, some components can be located proximate to the user, and some components can be located in a cloud environment or data center.

The GPUs can be embodied on one semiconductor substrate, included in a system with one or more other devices such as additional GPUs, a memory, and a CPU. The GPUs may be included on a graphics card that includes one or more memory devices and is configured to interface with a motherboard of a computer. The GPUs may be integrated GPUs (iGPUs) that are co-located with a CPU on one chip. Configured or configured to means, for example, designed, constructed, or programmed, with the necessary logic and/or features for performing a task or tasks.

Portions of disclosed examples or embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Examples of program code include both machine code, such as produced by a compiler, and files containing higher level code that may be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Those skilled in the art to which this application relates will appreciate that other and further additions, deletions, substitutions, and modifications may be made to the described embodiments. It is also to be understood that the terminology used herein is for the purpose of describing particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

Various aspects of the disclosure can be claimed, including the apparatuses, systems, and methods as noted in the Summary. Each of the noted aspects can have one or more of the additional features of the below dependent claims in combination.

What is claimed is:

1. A method, comprising:
decomposing an arithmetic operation being performed on a processing unit into a modular multiplication operation;
transforming the modular multiplication operation to a redundant representation consisting of a vector of integers;
mapping the redundant representation to inputs of a matrix multiplication process;
computing a result from an output of the matrix multiplication process; and
returning the result as a response to the arithmetic operation from the matrix multiplication process.

2. The method as recited in claim 1, wherein the matrix multiplication process is implemented by the processing unit.

3. The method as recited in claim 1, wherein the decomposing, decomposes a number used in the arithmetic operation into 8-bit bitwidth.

4. The method as recited in claim 1, wherein the processing unit utilizes 32-bit bitwidth and the largest modulus used in the transforming is 22-bits.

5. The method as recited in claim 1, wherein a modulus used in the transforming is smaller than 64 bits and the transforming uses fewer bits per column in the redundant representation.

6. The method as recited in claim 1, wherein the redundant representation has more than one row in the input matrix and the computing recomposes the result of each row prior to computing a subsequent row.

7. The method as recited in claim 1, wherein the result is recomposed from the output of the matrix multiplication process by offsetting each element of the output according to a placeholder value for each element.

8. The method as recited in claim 1, wherein the matrix multiplication process adds a row to a second matrix, where each row represents a different placeholder value.

9. The method as recited in claim 1, wherein the transforming selects a smaller modulus than specified by an application algorithm to improve performance on the processing unit.

10. The method as recited in claim 1, wherein the transforming uses preconditioning reducing computations during the transforming, where the preconditioning specifies the redundant representation uses pre-computed values.

11. The method as recited in claim 1, wherein the transforming uses a data format aligned to the matrix multiplication process reducing processing time of the matrix multiplication process.

12. The method as recited in claim 1, wherein the processing unit includes a dedicated matrix multiplication unit capable of performing the matrix multiplication process.

13. A system, comprising:
a processing unit capable of executing code; and
a matrix multiplication unit, capable of receiving an arithmetic operation, decomposing the input numbers into bitwidth blocks aligning to the format used by the processing unit, transforming the decomposed input numbers to a redundant representation consisting of a vector of integers, mapping the redundant representation to inputs of a matrix multiplication process supported by the matrix multiplication unit, computing a result from the output of the matrix multiplication process, and returning the result.

14. The system as recited in claim 13, wherein the processing unit is a central processing unit (CPU), a graphics processing unit (GPU), or a single instruction multiple data (SIMD) processing unit.

15. The system as recited in claim 13, wherein the processing unit includes the matrix multiplication unit.

16. A non-transitory computer program product having a series of operating instructions stored on a non-transitory computer-readable medium that directs a data processing apparatus, when executed thereby to perform operations, the operations comprising:
decomposing an arithmetic operation being performed on a processing unit into a modular multiplication operation;
transforming the modular multiplication operation to a redundant representation consisting of a vector of integers;
mapping the redundant representation to inputs of a matrix multiplication process;
computing a result from an output of the matrix multiplication process; and
returning the result as a response to the arithmetic operation from the matrix multiplication process.

17. The non-transitory computer program product as recited in claim 16, wherein the result is recomposed from the output of the matrix multiplication process by offsetting each element of the output according to a placeholder value for each element.

18. The non-transitory computer program product as recited in claim 16, wherein the transforming selects a smaller modulus than specified by an application algorithm to improve performance on the processing unit.

19. The non-transitory computer program product as recited in claim 16, wherein the transforming uses preconditioning reducing computations during the transforming, where the preconditioning specifies the redundant representation uses pre-computed values.

20. A processing unit, comprising:
a code execution system, capable of analyzing operations and instructions from code and to direct arithmetic operations that satisfy specified conditions to a matrix multiplication process; and
a matrix multiplication unit, capable of performing a matrix multiplication process, wherein the process receives an arithmetic operation, decomposes the input numbers into bitwidth blocks aligning to the format used by the processing unit, transforms the decomposed input numbers to a redundant representation consisting of a vector of integers, maps the redundant representation to inputs of a matrix multiplication process supported by the matrix multiplication unit, computes a result from the output of the matrix multiplication process, and returns the result.

21. The processing unit as recited in claim 20, wherein the processing unit provides operating parameters to the executing code, where the operating parameters specify one or more bitwidths supported by the matrix multiplication unit.

22. A processing unit system, comprising:
a code execution system, capable of analyzing, during a runtime processing of a processing unit of the processing unit system, a code block to determine if the code block is requesting an arithmetic operation that can be performed by a matrix multiplication process; and
a matrix multiplication system, capable of executing a matrix multiplication process on the arithmetic operation, wherein the process receives an arithmetic operation, decomposes the input numbers into bitwidth blocks aligning to the format used by the processing unit, transforms the decomposed input numbers to a redundant representation consisting of a vector of integers, maps the redundant representation to inputs of a matrix multiplication process supported by the matrix multiplication unit, computes a result from the output of the matrix multiplication process, and returns the result.

23. The processing unit system as recited in claim 22, wherein the matrix multiplication system is a matrix multiplication unit included with the processing unit.
